(19) United States
(12) Patent Application Publication
(10) Pub. No.: US 2008/0027835 A1
(43) Pub. Date: Jan. 31, 2008

(54) Methods for maintaining inventory records between audit periods

(75) Inventors: Scott Andrew LeMasters, East Peoria, IL (US); Andrew Christopher Stein, Morton, IL (US); Douglas Clifford Meyer, Morton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/507,426

(22) Filed: Aug. 22, 2006

Related U.S. Application Data
(60) Provisional application No. 60/853,304, filed on Jul. 31, 2006.

(51) Int. Cl. G06Q 10/00

(52) U.S. Cl. 705/28

(57) ABSTRACT

A method for maintaining inventory records between audit periods includes establishing a virtual bin associated with an actual inventory record and collecting data indicative of actual quantities of one or more products associated with an inventory. The data indicative of the actual quantities of each of the one or more products is compared with the inventory record associated with the corresponding product. An inventory adjustment factor is determined for each of the one or more products based on the comparison. The inventory adjustment factor for each of the one or more products is stored in the virtual bin. The method also includes adjusting the inventory record associated with each of the one or more products based on the stored inventory adjustment factor.

This application claims priority to and the benefit of the filing date of U.S. Provisional Patent Application No. 60/853,304, filed Jul. 31, 2006, which is herein incorporated by reference in its entirety.

### TECHNICAL FIELD

The present disclosure relates generally to an inventory control process and, more particularly, to methods for maintaining inventory records between audit periods.

### BACKGROUND

In certain business environments, accurate, reliable, and continuous accounting of inventory records is imperative to the operation of the business. Accordingly, inventory stocks associated with these business environments typically undergo inventory verification processes in which a portion of the inventory is physically counted and compared with inventory records. Inventory records may be subsequently adjusted to resolve discrepancies between data associated with the physical count and the inventory records. In certain situations, however, these adjustments may be made erroneously due, for example, to one or more inventory items that may be displaced or otherwise unaccounted for during the physical count process. When the part is eventually recovered and restocked, the inventory record (which may have been adjusted to reflect that the part is missing) may not be corrected until the next physical count process.

In certain situations, errors in inventory records may have serious implications. For example, a warehouse that deals with exporting and/or importing a portion of its inventory may be required to periodically provide inventory records to ensure conformance with any import/export control regulations (such as customs regulations, etc.). Typically, the inventory records must be accompanied with the appropriate certifications, authorizing that each product contained in the inventory has been authorized for import and/or export. In certain cases, failure to account for all products reflected on the inventory record may result in fines and/or permanent forfeiture of the products that are unaccounted for in the inventory records. Thus, in order to limit penalties imposed by auditing agencies, a system for accurately and efficiently maintaining inventory records between audit periods may be required.

At least one system has been developed to reconcile inventory records and physical inventory discrepancies for customs declarations. For example, U.S. Patent Publication No. 2004/0177013 (“the '013 publication”) to Zhou describes a periodic auditing system that collects inventory data, reports the inventory data to a customs authority, and downloads a return receipt indicating if the declaration is acceptable. If the declaration is acceptable, the system of the '013 publication may determine if a “book” inventory matches a physical inventory. If the book inventory matches the physical inventory, the book inventory is carried forward to a subsequent auditing period. If, however, the book inventory does not match the physical inventory an explanation report may be provided and the corresponding tax or penalty may be collected.

Although the system of the '013 publication may be configured to resolve inventory discrepancies during an auditing period, it may have several disadvantages. For example, the system of the '013 patent may do nothing to monitor and/or reconcile physical and “book” inventory discrepancies in real-time, prior to the auditing period. As a result, inventory discrepancies that may otherwise be reconcilable if detected prior to the audit period, may still be assessed a penalty by an auditing authority or regulatory agency.

The presently disclosed method for maintaining inventory records between auditing periods is directed toward overcoming one or more of the problems set forth above.

### SUMMARY OF THE INVENTION

According to one aspect, the present disclosure is directed toward a method for maintaining inventory records. The method may include establishing a virtual bin associated with an actual inventory record and collecting data indicative of actual quantities of one or more products associated with an inventory. The data indicative of the actual quantities of each of the one or more products may be compared with the actual inventory record associated with the corresponding product. An inventory adjustment factor for each of the one or more products may be determined based on the comparison and stored in the virtual bin. The method may also include adjusting the actual inventory record associated with each of the one or more products based on the stored inventory adjustment factor.

In accordance with another aspect, the present disclosure is directed toward a method for maintaining inventory records between audit periods. The method may include establishing a virtual inventory record based on an actual inventory record and collecting data indicative of actual quantities of one or more products associated with an inventory. Data indicative of the actual quantities of each of the one or more products may be compared with the actual inventory record associated with the corresponding product. The virtual inventory record associated with each of the one or more products may be periodically updated based on a change in the data indicative of the actual quantities of each of the one or more products. The method may also include adjusting the actual inventory record associated with each of the one or more products based on the virtual inventory record associated with each of the one or more products.

According to yet another aspect, the present disclosure is directed toward a computer readable medium for use on a computer system, the computer readable medium having computer executable instructions for performing a method for maintaining inventory records between audit periods. The method may include creating a virtual bin associated with an actual inventory record and collecting data indicative of actual quantities of one or more products associated with an inventory. Data indicative of the actual quantities of each of the one or more products may be compared with the actual inventory record associated with the corresponding product to determining an inventory adjustment factor for each of the one or more products. The inventory adjustment factor for each of the one or more products may be stored in the virtual bin. The inventory adjustment factor for each of the one or more products in the virtual bin may be updated based on a change in the data indicative of the actual quantities of each of the one or more products. The method may also include adjusting the actual inventory record associated with each of the one or more products based on the stored inventory adjustment factor associated with each of the one or more products.

### BRIEF DESCRIPTION OF THE DRAWINGS

FIG. 1 illustrates an exemplary disclosed inventory environment consistent with certain disclosed embodiments; and

FIG. 2 provides a flowchart depicting an exemplary method for maintaining inventory records consistent with certain disclosed embodiments.

### DETAILED DESCRIPTION

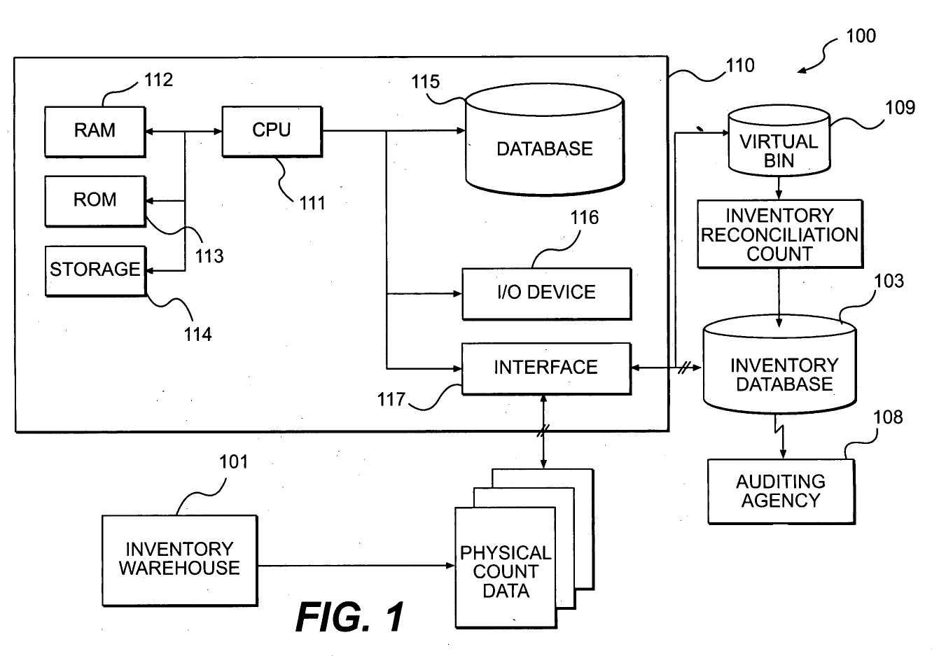

FIG. 1 provides a block diagram illustrating an exemplary disclosed inventory environment 100. Inventory environment 100 may include any type of environment associated with monitoring and/or managing an inventory that includes a population of elements. For example, inventory environment 100 may include a product warehouse configured to receive and distribute large numbers of products for operating a business. Inventory environment 100 may include, among other things, an inventory warehouse 101 containing a plurality of products, an inventory database 103, an auditing agency 108, a virtual bin 109, and a system 110 for maintaining inventory records.

Inventory warehouse 101 may include any type of facility for storing a plurality of products. Products, as the term is used herein, may include any physical or virtual element that may be used as a product associated with a business. Non limiting examples of physical products may include machines or machine parts or accessories such as, for example, electronic hardware or software; work implements; traction devices such as tires, tracks, etc.; transmissions; engine parts or accessories; fuel; or any other suitable type of physical product. Non limiting examples of virtual products may include inventory data, product documentation, software structures, software programs, financial data or documents such as stock records, or any other type of virtual product. Inventory warehouse 101 may include, for example, a parts depot, a product showroom, a document storage facility, or any other type of facility suitable for storing physical and/or virtual products.

Inventory database 103 may include any type of electronic data storage device that may store data information. Inventory database 103 may contain one or more inventory records associated with each of the plurality of products associated with inventory warehouse 101. Inventory database 103 may constitute a standalone computer system that includes one or more computer programs for monitoring and/or maintaining inventory records associated with inventory warehouse 101. Alternatively and/or additionally, inventory database 103 may be integrated as part of an inventory warehouse computer or system 110 for maintaining inventory records. It is also contemplated that inventory database 103 may include a shared database between one or more computer systems of business entities associated with inventory warehouse 101, such as an accounting division, a sales division, a supplier, or any other appropriate business entity that may typically deal with inventory warehouse 101.

Inventory database 103 may include one or more components suitable for storing data related to official inventory audits. For purposes of the present disclosure, official inventory audits may include one or more physical counts of one or more products associated with inventory warehouse 101. These official inventory audits may be performed primarily for the purpose of reporting inventory data to an auditing agency 108, such as an import control board or other public or private auditing organization. It is contemplated that one or more internal (i.e., unofficial) inventory audits may be periodically performed between audit periods. These internal inventory audits may include one or more physical counts, typically performed on a portion of inventory products within inventory warehouse 101. Internal inventory audits may be used primarily for inventory management processes associated with inventory warehouse 101 and may not be reported to auditing agency 108.

Physical count, as the term is used herein, may include any process by which one or more products associated with inventory warehouse 101 are identified and physically counted, in an attempt to account for each product of the product inventory. For example, each product may be included with a barcode for scanning by a barcode reader or other handheld scanning device. Data from the handheld scanning device may be uploaded into system 110, which may sort and count the scanned data to provide an output indicative of a quantity of products stored in its designated location within inventory warehouse 101. These physical counts may be performed either periodically or continuously. It is also contemplated that these physical counts may include statistical test count processes whereby a predetermined percentage of the inventory is counted to provide a minimum level of statistical confidence in the inventory record. The statistical test count data associated with the percentage may be subsequently applied to a larger portion of the inventory population, in order to avoid interfering with inventory warehouse operations.

Inventory database 103 may be communicatively coupled to one or more systems associated with auditing agency 108. For instance, inventory database 103 may be coupled via a secure communications network to one or more computer systems associated with auditing agency 108. As such, inventory database 103 may be accessible by auditing agency 108, either periodically or continuously, to allow auditing agency 108 to periodically verify inventory records, for such purposes as regulatory control, tax assessment, and/or import/export control. Alternatively and/or additionally, inventory database 103 may be selectively coupled to the auditing agency during certain predetermined auditing periods.

Auditing agency 108 may include any public or private entity that may be contracted to audit physical inventory associated with inventory warehouse 101. Auditing agency 108 may include, for example, an import control board, customs agency, tax agency, or any other type of governmental or private organization that may be authorized or sanctioned to audit inventory warehouse 101.

Auditing agency 108 may be designated by a government or other organization to issue certification notes for products imported in a particular jurisdiction. These certification notes may identify the serial number associated with the product and provide official notification that the product has been certified for commerce by the auditing agency. Auditing agency 108 may periodically verify, through one or more official inventory audits, that every product in inventory warehouse 101 is accompanied by or associated with an appropriate certification note. In certain situations, auditing agency 108 may be authorized to destroy and/or confiscate any products that do not have a corresponding certification note. Similarly, auditing agency 108 may be authorized to destroy and/or confiscate any certification notes that are not associated with a corresponding product. In certain cases, auditing agency 108 may impose fines or other penalties on organizations whose inventories do not comply with certain auditing verification and certification guidelines.

Virtual bin 109 may be communicatively coupled to both system 110 and inventory record 103. Virtual bin 109 may be configured to monitor and/or record differences between physical count data and inventory record data, without modifying data within inventory database 103, as inventory database 103 may be accessible by auditing agency 108. As a result, virtual bin 109 may enable system 110 and inventory management personnel to account for any differences prior to official agency audits, which may result in certain penalties associated with any inventory that may not be accounted for.

System 110 may include any type or processor-based system on which processes and methods consistent with the disclosed embodiments may be implemented. For example, as illustrated in FIG. 1, system 110 may include one or more hardware and/or software components configured to execute software programs, such as software for managing inventory environment 100, inventory monitoring software, or inventory transaction software. For example, system 110 may include one or more hardware components such as, for example, a central processing unit (CPU) 111, a random access memory (RAM) module 112, a read-only memory (ROM) module 113, a storage 114, a database 115, one or more input/output (I/O) devices 116, and an interface 117. Alternatively and/or additionally, system 110 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and/or CPU 111. For example, database 115 may include historical data, such as previous adjustments to inventory records based on physical count data and/or previous inventory records. CPU 111 may access the information stored in database 115 for comparing the physical count data with the inventory record data to determine whether an adjustment to the inventory record may be required. CPU 111 may also analyze current and previous inventory count records to identify trends in inventory count adjustment. These trends may then be recorded and analyzed to adjust one or more aspects associated with an inventory control process, which may potentially reduce inventory management errors leading to product loss and/or inventory write-off. It is contemplated that database 115 may store additional and/or different information than that listed above.

I/O devices 116 may include one or more components configured to communicate information with a user associated with system 110. For example, I/O devices may include a console with an integrated keyboard and mouse to allow a user to input parameters associated with system 110. I/O devices 116 may also include a display including a graphical user interface (GUI) for outputting information on a monitor. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via a communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via a communication network.

System 110 may be configured to monitor and/or manage inventory records, including product transactions, product distribution, or other changes in product inventory such as, for example, surpluses and deficits uncovered during physical counts. For example, as illustrated in FIG. 1, system 110 may be communicatively coupled to each of a virtual bin 109 and an inventory record 103. System 110 may be configured to periodically or continuously monitor the data in both virtual bin 109 and inventory record 103. Additionally, system 110 may be configured to update, store, modify, or analyze data associated with each of virtual bin 109 or inventory record 103 based on actual inventory quantities derived from physical count data.

System 110 may be configured to update and/or reconcile the inventory record with the data contained in virtual bin 109 in anticipation of or during an annual auditing period. During the auditing period an official inventory audit may be performed. For purposes of the present disclosure this official inventory audit may include one or more physical counts of the entire inventory in the warehouse. Additionally, the official inventory audit may require full or partial interruption in the operations of the inventory warehouse, depending upon the requirement of a particular auditing agency. This may allow for a complete static count of all products in the inventory, in order to ensure accuracy of the entire inventory record, prior to reporting to the auditing agency. System 110 may update virtual bin 109 after completion of the official inventory audit for future reconciliation of the inventory record.

System 110 may be configured to provide an inventory report to the auditing agency in order to verify that all products within inventory warehouse 101 have been properly accounted for. The inventory report may be provided in response to a request from the auditing agency, in response to an auditing deadline, or automatically on a periodic basis, depending on the requirements of the auditing agency. For example, at the end of each year, an import/export control board associated with a government entity may require that all inventories must be verified and each product associated with the inventory must be accompanied by an import certification. Any excess certificates and/or products that are not accompanied by a respective product and/or certificate may be confiscated and/or destroyed.

Processes and methods consistent with the disclosed embodiments may provide inventory control processes that reduce costs associated with misplaced inventory or temporary errors in inventory accounting by providing a virtual bin (or virtual inventory account) separate from an inventory record that is audited by an auditing agency. As a result, any temporary discrepancy between actual inventory and the inventory of record (such as a misplaced part on an inventory supply shelf) may be addressed and corrected prior to reporting the discrepancy to an auditing agency, minimizing unnecessary and potentially costly inventory reconciliation activities that may be required by the auditing agency.

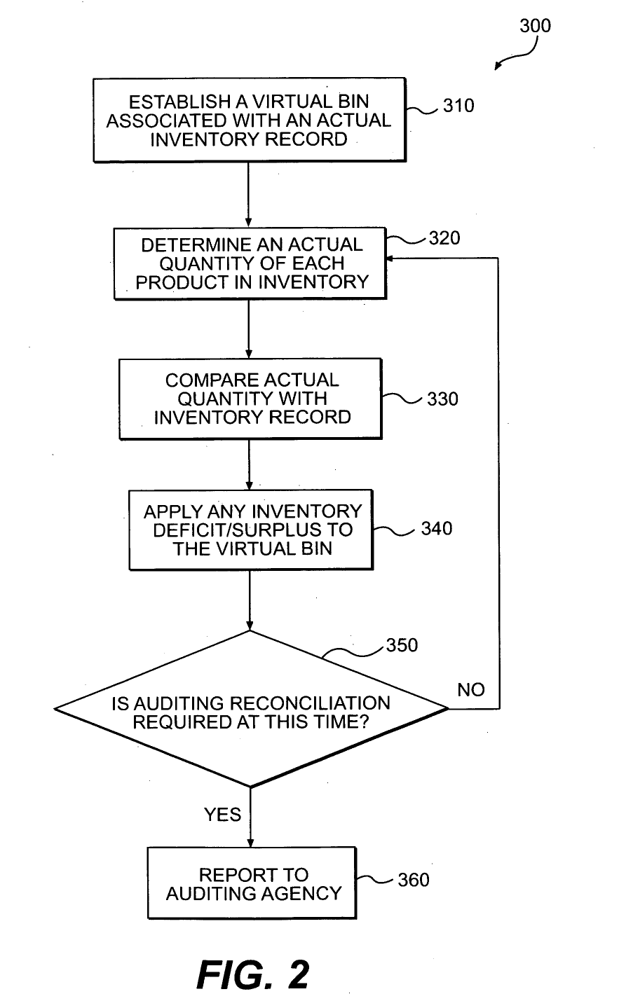

FIG. 2 provides a flowchart 300 depicting an exemplary method for maintaining inventory records between auditing periods. The method may include establishing a virtual bin associated with an actual inventory record (Step 310). For example, CPU 111 may execute one or more computer programs in communication with an inventory database 103 (which may be included as part of database 115). The computer program may create a virtual bin that includes each part number associated with an inventory record stored in inventory database 103. Each part number of the virtual bin may have a corresponding inventory adjustment factor associated with a discrepancy between the current inventory record and physical count data.

Once the virtual bin has been established, an actual quantity of each product in inventory may be determined (Step 320). This determination may be based on physical count data associated with an internal inventory audit. This physical count may be performed manually by one or more inventory management personnel. Alternatively, the physical count may include a semi-automated process whereby barcodes affixed to each product may be scanned using optical scanning devices or other handheld scanning instruments. The scanned data may be uploaded to system 110, which may automatically sort and count the scanned data to produce physical count data.

Once the actual quantity of each product in inventory has been determined, physical count data associated with each product may be compared with an inventory record associated with the corresponding product (Step 330). For example, CPU 111 may execute software that compares an actual quantity associated with a particular part number (as determined by the physical count) with corresponding inventory record associated with the part number.

The software may also determine, based on the comparison, an inventory adjustment factor indicative of the difference (e.g., deficit or surplus) between the actual quantity and the inventory record. For example, if the actual quantity of part number “X” determined by a physical count is 13 units, while the inventory record indicates that there are 15 units, the software may assign an inventory adjustment factor of −2 to part number “X”. System 110 may apply this inventory adjustment factor to the virtual bin (Step 340). Should one or more of the parts associated with the deficit in the virtual bin be recovered during a subsequent physical count, an inventory adjustment factor (presumably a surplus) may be applied to the virtual bin to reflect this recovery. Thus, the virtual bin may be reflective of any inventory discrepancy between the physical count data and the product inventory. By adjusting virtual bin 109 by the inventory adjustment factor prior to the annual audit process, inventory management processes may be directed toward reconciling any discrepancies between the inventory record and the inventory warehouse data prior to reporting to the auditing agency.

Once any inventory adjustment factor has been applied to the virtual bin, system 110 may determine if auditing reconciliation may be required (Step 350). This determination may be based on a deadline provided by an auditing agency, a prompt from an inventory manager, or, in certain circumstances, may be recommended by system 110. According to one embodiment, if an auditing agency provides an audit period whereby an inventory record may be supplied anytime prior to a 1-month audit deadline, system 110 may recommend to an inventory manager the most advantageous time to provide the inventory record, based on data stored in the virtual bin. This recommendation may be based on a net product loss, a net value loss, or other suitable criteria.

If an auditing reconciliation is required (Step 350: Yes) the inventory record may be adjusted based on data stored in the virtual bin. Following the example above, if, during the audit period, system 110 determines that virtual bin is reporting a net value loss below an acceptable threshold level, system 110 may provide a recommendation to adjust the inventory record based on data stored in virtual bin and provide the inventory record to the auditing agency. Alternatively, system 110 may automatically provide the adjusted inventory record automatically in response to prompt from the inventory manager. Alternatively, if an auditing reconciliation is not required (Step 350: No), system 110 may continue to maintain inventory adjustment factors for each of the one or more products associated with inventory warehouse 103.

Although certain aspects of the exemplary method may be illustrated and/or described in connection with or being performed by system 110, it is contemplated that the method may alternatively be implemented or performed manually, without the use of system 110.

### INDUSTRIAL APPLICABILITY

Although methods consistent with the disclosed embodiments are described in relation to product warehouse environments, they may be applicable to any environment where management of tangible or intangible inventory may be required. According to one embodiment, the disclosed methods for managing inventory records between audit periods may enable organizations, particularly those that may be required to interact with external regulatory or auditing agencies, to maintain inventory records in real-time, without modifying the actual inventory record until an appropriate auditing period. As a result, discrepancies between actual inventory stock and inventory records may be reconciled prior to the auditing period.

The presently disclosed methods for managing inventory records between audit periods may have several advantages. First, because the method involves monitoring and recording inventory discrepancies (e.g., surpluses or deficits) in a virtual bin and reconciling these discrepancies with the inventory record only during an audit period, inventory error may be corrected prior to a regulatory agency audit. As a result, penalties or fees associated with inventory discrepancies may be significantly reduced or eliminated.

In addition, the presently disclosed inventory record management system may have certain cost advantages. For instance, because inventory error may be tabulated in the virtual bin on a real-time basis, inventory management resources and funds may be directed toward resolving discrepancies in inventory that present the greatest overall financial impact to the organization. As a result, the presently disclosed method may reduce the need for large, expansive, and costly inventory counts associated with annual audits that may slow warehouse operations and decrease personnel productivity.

It will be apparent to those skilled in the art that various modifications and variations can be made to the disclosed methods for managing inventory records between audit periods. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for maintaining inventory records, comprising:
establishing a virtual bin associated with an actual inventory record;
collecting data indicative of actual quantities of one or more products associated with an inventory;
comparing the data indicative of the actual quantities of each of the one or more products with the inventory record associated with the corresponding product;
determining an inventory adjustment factor for each of the one or more products based on the comparison;
storing the inventory adjustment factor for each of the one or more products in the virtual bin; and
adjusting the inventory record associated with each of the one or more products based on the stored inventory adjustment factor.

2. The method of claim 1, wherein collecting data includes:
selecting one or more part numbers associated with the one or more products; and
performing a physical count of each product corresponding to the one or more selected part numbers.

3. The method of claim 2, further including:
analyzing the inventory record based on historical inventory records;
identifying one or more trends in inventory records adjustments based on the analysis; and
modifying a inventory control process to address the one or more trends in inventory records adjustments.

4. The method of claim 3, wherein modifying an inventory control process includes performing one or more additional physical counts at predetermined intervals.

5. The method of claim 1, wherein the inventory adjustment factor includes a net inventory adjustment factor, the net inventory adjustment factor including a sum of inventory adjustment factors since a preceding auditing reconciliation period.

6. The method of claim 1, wherein the storing further includes updating an inventory adjustment factor for each of the one or more products in the virtual bin based on a change in the data indicative of the actual quantities of each of the one or more products.

7. The method of claim 1, wherein the adjusting further includes reporting the adjusted inventory record to an auditing agency in response to a request from the auditing agency.

8. The method of claim 1, wherein the adjusting further includes reporting the adjusted inventory record to an auditing agency by an auditing reconciliation deadline.

9. The method of claim 1, wherein the adjusting further includes reporting the adjusted inventory record to an auditing agency if the adjusted inventory record is substantially identical to the inventory record.

10. A method for maintaining inventory records, comprising:
establishing a virtual inventory record based on an actual inventory record;
collecting data indicative of actual quantities of one or more products associated with an inventory;
comparing the data indicative of the actual quantities of each of the one or more products with the actual inventory record associated with the corresponding product;
periodically updating the virtual inventory record associated with each of the one or more products based on a change in the data indicative of the actual quantities of each of the one or more products; and
adjusting the actual inventory record associated with each of the one or more products based on the virtual inventory record associated with each of the one or more products.

11. The method of claim 10, wherein collecting data includes:
selecting one or more part numbers associated with the one or more products; and
performing a physical count of each product corresponding to the one or more selected part numbers.

12. The method of claim 11, further including:
analyzing the adjusted actual inventory record based on historical inventory records;
identifying one or more trends in inventory records adjustments based on the analysis; and
modifying a inventory control process to address the one or more trends in inventory records adjustments.

13. The method of claim 12, wherein modifying an inventory control process includes performing one or more additional physical counts at predetermined intervals.

14. The method of claim 10, wherein the adjusting further includes reporting the adjusted actual inventory record to an auditing agency in response to a request from the auditing agency.

15. The method of claim 10, wherein the adjusting further includes reporting the adjusted actual inventory record to an auditing agency by an auditing reconciliation deadline.

16. The method of claim 10, wherein the adjusting further includes reporting the adjusted actual inventory record to an auditing agency if the adjusted actual inventory record is substantially identical to the actual inventory record.

17. A computer readable medium for use on a computer system, the computer readable medium having computer executable instructions for performing a method comprising:
creating a virtual bin associated with an inventory record;
collecting data indicative of actual quantities of one or more products associated with an inventory;
comparing the data indicative of the actual quantities of each of the one or more products with the inventory record associated with the corresponding product;
determining an inventory adjustment factor for each of the one or more products based on the comparison;
storing the inventory adjustment factor for each of the one or more products in the virtual bin;
periodically updating the inventory adjustment factor for each of the one or more products in the virtual bin based on a change in the data indicative of the actual quantities of each of the one or more products; and
adjusting the inventory record associated with each of the one or more products based on the stored inventory adjustment factor associated with each of the one or more products.

18. The computer readable medium of claim 17, wherein collecting data includes:
selecting one or more part numbers associated with the one or more products; and
prompting a user for physical count data associated with each product corresponding to the one or more selected part numbers.

19. The computer readable medium of claim 18, further including:
analyzing the inventory record based on historical inventory records;
identifying one or more trends in inventory records adjustments based on the analysis; and
modifying a inventory control process to address the one or more trends in inventory records adjustments.

20. The computer readable medium of claim 17, wherein the inventory adjustment factor includes a net inventory adjustment factor, the net inventory adjustment factor including a sum of inventory adjustment factors since a preceding auditing reconciliation period.
